(19) United States
(12) Patent Application Publication
(10) Pub. No.: US 2019/0126950 A1
(43) Pub. Date: May 2, 2019

(54) SEMIACTIVE DAMPER

(71) Applicant: KYB CORPORATION, Tokyo (JP)

(72) Inventor: Takayuki OGAWA, Tokyo (JP)

(73) Assignee: KYB CORPORATION, Tokyo (JP)

(21) Appl. No.: 16/094,015

(22) PCT Filed: Apr. 19, 2017
(86) PCT No.: PCT/JP2017/015735

§ 371 Date: Oct. 16, 2018

(30) Foreign Application Priority Data
Aug. 30, 2016 (JP) 2016-167521

(51) Int. Cl. B61F 5/24; F16F 15/023; F16F 9/46; B60G 17/08

(52) U.S. Cl. CPC B61F 5/24; F16F 15/023; F16F 9/46; B60G 17/08; B60G 2202/24; B60G 2600/184; B60G 2204/82; B60G 2400/5182; B60G 2500/10

(57) ABSTRACT

A semiactive damper of the present invention includes a cylinder, a rod movably inserted into the cylinder, a piston slidably inserted into the cylinder and comparting the interior of the cylinder into a rod-side chamber and a piston-side chamber, a tank, a suction passage permitting only flow of a hydraulic fluid from the tank to the piston-side chamber, a damping passage communicating the rod-side chamber with the tank or the rod-side chamber with the piston-side chamber, and a variable damping valve provided on the damping passage, and a detecting portion for detecting an expansion and contraction direction according to pressure in the piston-side chamber.

### TECHNICAL FIELD

The present invention relates to improvement of a semiactive damper.

### BACKGROUND ART

Conventionally, as a semiactive damper of such a type, for example, those used by being interposed. between a vehicle body and a trolley for suppression of vibrations in a right-and-left direction relative to the traveling direction of the vehicle body of a rail vehicle are known.

More specifically, as disclosed, for example, in JP 11-44288 A, a semiactive damper includes an actuator having a cylinder, a piston slidably inserted in the cylinder and co acting the interior of the cylinder into a rod-side chamber and a piston-side chamber, and a rod inserted into the cylinder and coupled to the piston, the actuator being interposed between a vehicle body and a trolley, a tank, a first opening/closing valve provided on a first passage communicating the rod side chamber with the piston-side chamber, a second opening/closing valve provided on a second passage communicating the piston-side chamber with the tank, a discharge passage connecting the rod-side chamber to the tank, and a variable relief valve provided on the discharge passage and capable of changing a valve opening pressure.

In the case of the semiactive damper configured in the above manner, when the first opening/closing valve is opened and the second opening/closing valve is closed, a damping force is exhibited only on the contraction side, and in contrast when the first opening/closing valve is closed and the second opening/closing valve is opened, a damping force is exhibited only on the expansion side. Thus, the semiactive damper can function as a skyhook damper on the basis of Karnopp control.

### SUMMARY OF THE INVENTION

The conventional semiactive damper employs an electromagnetic valve using a solenoid for the first opening/closing valve, the second opening/closing valve, and the variable relief valve. These valves are large in size and expensive, so that. the entire apparatus is large and the manufacturing cost increases.

In addition, the opening and closing of the first opening/closing valve and the second opening/closing valve involve a response delay. When the vehicle body or the trolley vibrates at a high frequency under the situation that the semiactive damper exhibits a large damping force, on the contrary, the vehicle body or the trolley is vibrated and chatter vibration occurs in the vehicle body, resulting in the problem that the vehicle ride quality is deteriorated.

It is an object of the present invention to provide a semiactive damper that is capable of reducing the size and the cost and increasing the vehicle ride quality.

The semiactive damper of the present invention includes a cylinder, a rod movably inserted into the cylinder, a piston. slidably inserted into the cylinder and comparting the interior of the cylinder into a rod-side chamber and a piston-side chamber, a tank, a suction passage permitting only flow of a hydraulic fluid from the tank to the piston-side chamber, a damping passage communicating the rod-side chamber with the tank or the rod-side chamber with the piston-side chamber, and a variable damping valve provided on the damping passage, and a detecting portion for detecting an expansion and contraction direction according to pressure in the piston-side chamber.

### BRIEF DESCRIPTION OF DRAWINGS

FIG. 1 is a circuit diagram of a semiactive damper of an embodiment.

FIG. 2 is a schematic plan view of a rail vehicle equipped with the semiactive damper of an embodiment.

FIG. 3 is a control block diagram of a control portion of the semiactive damper of an embodiment.

FIG. 4 is a circuit diagram of a semiactive damper of a first variation of an embodiment.

FIG. 5 is a circuit diagram of a semiactive damper of another variation of an embodiment.

FIG. 6 is a circuit diagram illustrating a first variation of a variable damping valve.

### DESCRIPTION OF EMBODIMENTS

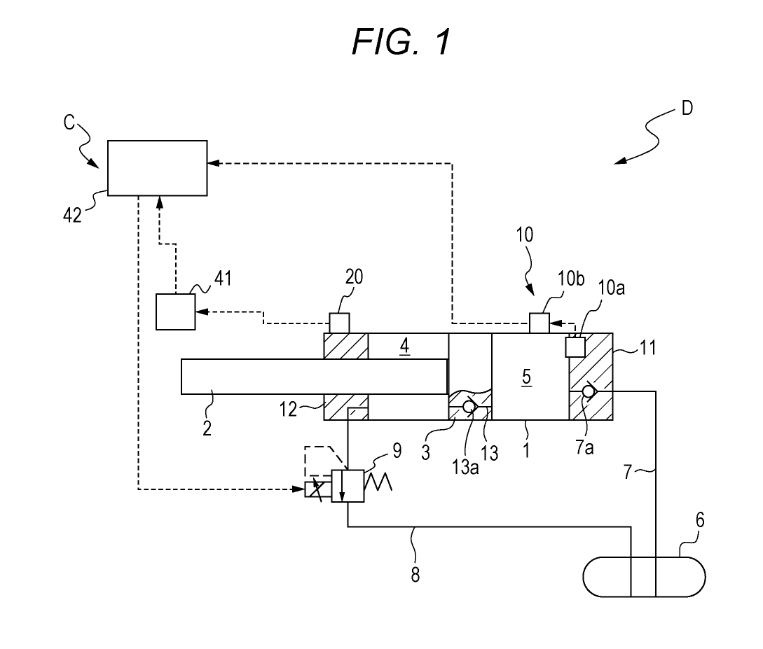

The present invention is described below on the basis of embodiments illustrated in the drawings. As illustrated in FIG. 1, a semiactive damper D of an embodiment is configured to include a cylinder 1, a rod 2 movably inserted. into the cylinder 1, a piston 3 slidably inserted into the cylinder 1 and comparting the interior of the cylinder 1 into a rod-side chamber 4 and a piston-side chamber 5, a tank 6, a suction. passage 7, a damping passage 8, a variable damping valve 9, and a detecting portion 10 for detecting an expansion. and contraction direction.

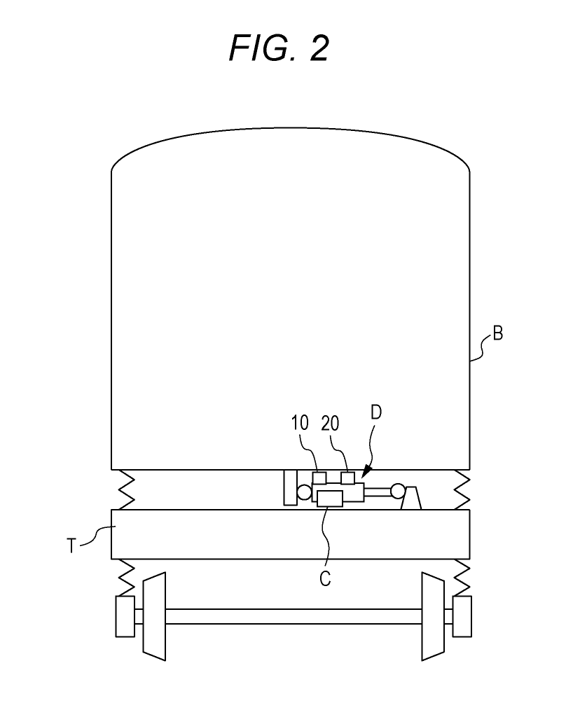

In the present example, the semiactive damper D is used as a vibration control device for the vehicle body B of a rail vehicle. As illustrated in FIG. 2, the semiactive damper D is set between the vehicle body B and the trolley T, and exhibits a damping force to suppress vibrations in a horizontally lateral direction. relative to the vehicle traveling direction of the vehicle body B.

The portions of the semiactive damper D are described in detail below. The cylinder 1 has a cylindrical shape. The right end in FIG. 1 is closed by a lid 11, and the left end in FIG. 1 is provided. with a rod guide 12 having an annular shape. in addition, the rod 2 movably inserted into the cylinder 1 is slidably inserted into the rod guide 12. This rod. 2 has one end protruding out of the cylinder 1, and the other end. in the cylinder 1 is coupled to the piston 3, which is slidably inserted into the cylinder 1.

The piston 3, when slidably inserted into the cylinder 1, comparts the interior of the cylinder 1 into the rod-side chamber 4 and the piston-side chamber 5. A space between. the outer circumference of the rod guide 12 and the cylinder 1 is sealed by a sealing member, which is not illustrated, so that the interior of the cylinder 1 is maintained in a closed state. Furthermore, the rod-side chamber 4 and the piston-side chamber 5 comparted by the piston 3 in the cylinder 1 are filled with a hydraulic oil, which is a hydraulic fluid. In addition, the tank 6 is filled with a gas in addition to the hydraulic oil, In the interior of the tank 6, it is not particularly necessary to compress and charge the gas into a pressurized state. In addition, as the hydraulic fluid, a liquid different from the hydraulic oil may be used.

In addition, the left end. of the rod 2 in FIG. 1 and the lid 11 closing the right end of the cylinder 1 are provided. with an attachment portion, which is not illustrated, so that the semiactive damper D can be interposed between the vehicle body B and the trolley T of a rail vehicle.

Furthermore, the damping passage 8 connects the rod-side chamber 4 to the tank 6, and the damping passage 8 is provided. with the variable damping valve 9. In the present example, the variable damping valve 9 is a variable relief valve capable of changing the valve opening pressure. The variable damping valve 9 can adjust the valve opening pressure depending on the amount of current to be supplied. When the pressure of the rod-side chamber 4 reaches the valve opening pressure, the variable damping valve 9 is opened and the rod-side chamber 4 is communicated with the tank 6, and the pressure of the rod-side chamber 4 is adjusted. to the valve opening pressure. However, the flow of the hydraulic oil from the tank 6 to the rod-side chamber 4 prevented. Thus, in the present example, the damping passage 8 is set to a one-way passage that permits only the flow of the hydraulic oil from the rod-side chamber 4 to the tank 6 by means of the variable damping valve 9.

In the present example, the variable damping valve 9 is an electromagnetic relief valve with a solenoid. When. the amount of current becomes maximum, the valve opening pressure becomes minimum. When the current is not supplied, the valve opening pressure becomes maximum. The valve opening pressure is changed depending on the amount of current to be supplied. In addition, as the variable damping valve 9, other than a relief valve that can adjust the valve opening pressure, a valve with a different structure, e.g, a variable throttle valve, a spool valve, or a rotary valve that can adjust the opening area depending on the amount of current to be suppled can also be used.

Furthermore, the semiactive damper D of the present example includes a flow straightening passage 13 that permits only the flow of the hydraulic oil from the piston-side chamber 5 to the rod-side chamber 4 and the suction passage 7 that permits only the flow of the hydraulic oil from the tank 6 to the piston-side chamber 5. Thus, when the semiactive damper D of the present example is expanded and contracted, the hydraulic oil invariably pushed out of the cylinder 1 to the damping passage 8. Furthermore, the variable damping valve 9 applies resistance to the flow of the hydraulic oil discharged from the cylinder 1. The semiactive damper D of the present example is configured to be a uniflow-type damper.

More specifically, the flow straightening passage 13 communicates the piston-side chamber 5 with the rod-side chamber 4 and is provided with a check valve 13a so as to be set to a one-way passage that permits only the flow of the hydraulic oil from the piston-side chamber 5 to the rod-side chamber 4. Furthermore, the suction passage 7 communicates the tank 6 with the piston-side chamber 5 and is provided with a check valve 7a so as to be set. to a one-way passage that permits only the flow of the hydraulic oil from the tank 6 to the piston-side chamber 5. In the present example, the flow straightening passage 13 is provided in the piston 3, and the suction passage 7 is provided in the lid 11, but they may be provided in different locations.

In the case of the semiactive damper D configured in the above manner, the flow straightening passage 13, the suction. passage 7 and the damping passage 8 communicate the rod-side chamber 4, the piston-side chamber 5 and the tank 6 in a daisy chain, In addition, the flow straightening passage 13, the suction passage 7 and the damping passage 8 are set to a one-way passage.

Thus, when. the semiactive damper D is operated to be expanded, the hydraulic oil is discharged from the rod-side chamber 4, which is compressed, to the damping passage 8, and the hydraulic oil is charged to the piston-side chamber 5, which is enlarged, from the tank 6 through. the suction passage 7. Furthermore, the hydraulic oil discharged from the rod-side chamber 4 is moved to the tank 6 via the variable damping valve 9. Therefore, the semiactive damper D generates a damping force of a value obtained when the pressure in the rod-side chamber 4 is multiplied by the pressure receiving area of the piston 3 on the rod-side chamber 4 side. In contrast, when the semiactive damper D is operated to be contracted, the hydraulic oil is moved from the piston-side chamber 5, which is compressed, to the rod-side chamber 4 through the flow straightening passage 13. In addition, in this case, because the rod 2 enters the cylinder 1, the hydraulic oil corresponding to the volume for the entry of the rod 2 becomes excessive in the cylinder 1 and is discharged from the rod-side chamber 4 to the damping passage 8. Furthermore, the hydraulic oil discharged from the rod-side chamber 4 is moved to the tank 6 via the variable damping valve 9. Therefore, the pressures in the rod-side chamber 4 and the piston-side chamber 5 are adjusted to the valve opening pressure of the variable damping valve 9. The difference between the pressure receiving area of the piston 3 subject to the pressure of the piston-side chamber 5 and the pressure receiving area of the piston 3 subject to the pressure of the rod-side chamber 4 is a cross-sectional area of the rod 2. Therefore, the semiactive damper D generates a damping force of a value obtained when the pressure in the rod-side chamber 4 is multiplied by the cross-sectional area of the rod 2.

When the semiactive damper D is expanded and contracted by the external force, the hydraulic oil is invariably discharged from the cylinder 1 and is returned to the tank 6 via the damping passage 8. The hydraulic oil for shortage in the cylinder 1 is supplied into the cylinder 1 from the tank 6 via the suction passage 7. The variable damping valve 9 is resistance to the flow of the hydraulic oil, and the pressure in the cylinder 1 is adjusted to the valve opening pressure. Therefore, the semiactive damper D functions as a passive uniflow-type damper.

In addition, in the case of this semiactive damper D, the cross-sectional area of the rod 2 is half of the cross-sectional area of the piston 3 so that the pressure receiving area of the piston 3 on the rod-side chamber 4 side is half of the pressure receiving area on the piston-side chamber 5 side. Thus, when the valve opening pressure of the variable damping valve 9 is the same in the case of the expansion operation and in the case of the contraction operation, the damping forces generated. in both cases of expansion. and contraction are equal, so that the amounts of hydraulic oil relative to the amount of displacement, of the semiactive damper D are also the same in both cases of expansion and contraction.

The detecting portion 10 includes a pressure sensor 10a for detecting the pressure in the piston-side chamber 5 and a determining portion 10b for determining the expansion and contraction. direction of the semiactive damper D on the basis of the pressure detected by the pressure sensor 10a. When the semiactive damper D of the present example is operated. to be expanded, the hydraulic oil is supplied to the piston-side chamber 5, which is enlarged, from the tank 6 through the suction passage 7, and the pressure in the piston-side chamber 5 becomes almost equal to the tank pressure. When. the semiactive damper D of the present example is operated to be contracted, the hydraulic oil of the piston-side chamber 5, which is compressed, is supplied to the rod-side chamber 4 through the flow straightening passage 13, and the pressure in the piston-side chamber 5 is almost equal to the rod-side chamber 4. In the case of the contraction operation of the semiactive damper D, the pressure of the rod-side chamber 4 is adjusted to the valve opening pressure of the variable damping valve 9, and the pressure of the piston-side chamber 5 is also higher than the tank pressure. As described. above, the situations of the pressure in the piston-side chamber 5 are different between the expansion operation and the contraction operation of the semiactive damper D. When the pressure sensor 10a detects the pressure in the piston-side chamber 5, the expansion and contraction direction can be detected. Specifically, the tank pressure or a pressure value slightly higher than the tank pressure is preset as a threshold value. The determining portion 10b compares the pressure detected by the pressure sensor 10a and the threshold value to detect the expansion and contraction direction. More specifically, when. the pressure detected by the pressure sensor 10a is less than the threshold. value, the determining portion 10b determines that the semiactive damper D is in the expansion operation and outputs a signal indicating the expansion operation to a control portion C. When the pressure detected. by the pressure sensor 10a is equal to or more than the threshold value, the determining portion 10b determines that the semiactive damper D is in the contraction operation. and outputs a signal indicating the contraction operation. to the control portion C. The detecting portion 10 may be configured. of a pressure switch instead of being configured of the pressure sensor 10a and the determining portion 10b. The pressure switch outputs an ON signal when the pressure in the piston-side chamber 5 is equal to or more than. a predetermined pressure. Therefore, when the predetermined pressure is set to the aforementioned threshold value, the ON signal is a signal indicating the contraction operation of the semiactive damper D. In contrast, when the pressure switch does not generate an ON signal, it is determined that the semiactive damper D is in the expansion operation.

In addition, the cylinder 1 is provided with an. acceleration sensor 20. The acceleration sensor 20 detects an axial acceleration a acting on the cylinder 1 and inputs it to the control portion C. Thus, as illustrated in FIG. 2, the cylinder is coupled to the vehicle body B, which is a vibration control subject, and the rod 2 is coupled to the trolley T. When the semiactive damper D is attached to the rail vehicle, the acceleration sensor 20 can detect an acceleration almost equal to the acceleration in a horizontal lateral direction of the vehicle body B.

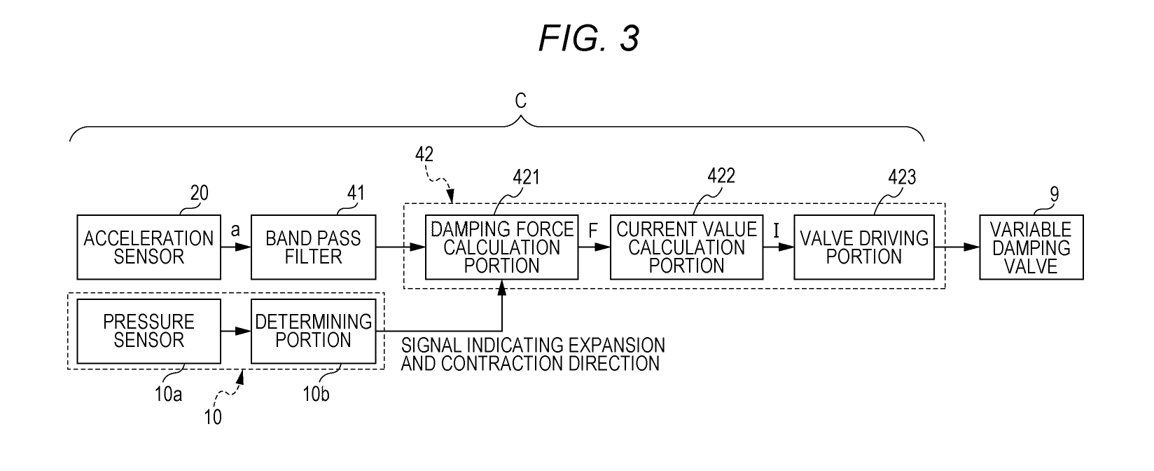

Next, as illustrated in FIGS. 1 and 3, the control portion C is configured to include a band pass filter 41 for removing a steady acceleration during curving traveling, a drift component, and noises contained in the acceleration a detected by the acceleration sensor 20, and a control processing portion 42 for outputting a control command to the variable damping valve 9 on the basis of the acceleration a filtered by the band pass filter 41 and the expansion and contraction direction of the semiactive damper D detected by the detecting portion 10. The control portion C controls the damping force output by the semiactive damper D. The band pass filter 41 removes a steady acceleration during curving traveling contained in the acceleration a Therefore, only vibrations that deteriorate the ride quality can be suppressed.

As illustrated in FIG. 3, the control processing portion 42 is configured to include a damping force calculation portion 421 for determining a damping force F to be generated by the semiactive damper D on the basis of the acceleration a detected by the acceleration sensor 20 and the expansion and contraction direction. detected by the detecting portion 10, a current value calculation portion 422 for determining a current value I applied to the variable damping valve 9 on the basis of the damping force F, and a valve driving portion 423 for supplying a current according to the current value I to the variable damping valve 9 upon receipt of an input of the current value I.

In the present example, the damping force calculation portion 421 is adapted. to function the semiactive damper D as a skyhook damper on the basis of the Karnopp control law and determines the damping force F on the basis of the acceleration a and the expansion and contraction direction detected. by the detecting portion 10. In the Karnopp control law, when a skyhook damping coefficient is Cs, and the acceleration of the vehicle body B, which is a vibration. control subject, is V, in cases where the direction. of velocity V corresponds to the expansion and contraction direction of the semiactive damper D, the damping force F is determined by F=Cs×V, and when they do not correspond, the damping force F is zero. In other words, in the Karnopp control law, under the situation that the semiactive damper D exhibits the damping force and the vibration of the vibration control subject can be suppressed, the damping force is exhibited and the vibration is suppressed. Under the situation that the vibration of the vibration control subject cannot be suppressed, the damping force is reduced to the possible extent and the vibration control subject is not vibrated. The velocity V of the vehicle body B is obtained when the acceleration. a detected by the acceleration sensor 20 is differentiated. The expansion and contraction direction of the semiactive damper D is detected by the detecting portion 10. Therefore, the damping force calculation portion 421 can grasp both of them.

When the velocity V of the vehicle body B is positive in the left direction in FIG. 2, and the expansion and contraction direction of the semdactive damper D is positive on the contraction side, the damping force calculation portion 421 determines the damping force F in the manner described. below. When the reference symbol of the velocity V is positive and the signal from the detecting portion 10 indicates contraction, or when the reference symbol of the velocity V is negative and the signal from the detecting portion 10 indicates expansion, the damping force calculation. portion 421 calculates F=Cs×V and determines the damping force F. When the reference symbol of the velocity V is positive and the signal from the detecting portion 10 indicates expansion, or when the reference symbol of the velocity V is negative and the signal from the detecting portion 10 indicates contraction, the damping force calculation portion 421 determines that the damping force F is zero.

As described above, because the semiactive damper D, which includes the detecting portion 10, can detect the expansion and contraction direction and can function as a skyhook damper on the basis of the Karnopp control law. The acceleration sensor 20 may directly be attached to the vehicle body B. However, when. the acceleration sensor 20 is attached to the semiactive damper D, a wiring operation is not necessary when the semiactive damper D is set to a rail vehicle. In addition, the semiactive damper D may not include the acceleration sensor 20 and may receive an input of the acceleration of the vibration control subject from the outside. In addition, the semiactive damper D may receive an input of a target damping force to be output instead of the acceleration. In the case of receipt of an input of the target damping force, under the situation that the direction of generation of the target damping force differs from the expansion and contraction direction detected by the detecting portion 10, the semiactive damper D can generate a damping force in the same direction as the direction of the generation of the target damping force. Therefore, also in the case of receipt of an input of the target damping force, it is sufficient that the damping force F is determined to be the target damping force or zero depending on the expansion and contraction direction detected by the detecting portion 10.

Next, the current value calculation. portion 422 determines the current value 1 supplied to the variable damping valve 9 on the basis of the damping force F determined in the manner described above. The valve opening pressure varies in proportion to the amount of current to be supplied, and the variable damping valve 9 has the property of having a pressure override in which the pressure drop increases depending on the flow rate passed. The current value calculation portion 422 determines the current value I in view of the pressure override. When the amount of current to be supplied becomes maximum, the valve opening pressure of the variable damping valve 9 becomes minimum. Therefore, when the damping force F is zero, the current value calculation portion 422 sets the current value I to a maximum value so that the damping force of the semiactive damper D becomes minimum.

In the present example, the valve driving portion 423 is a driver that drives the solenoid, which is not illustrated, of the variable damping valve 9. Upon receipt of the input of the current value I, the current of the amount of the current according to the current value I is supplied to the variable damping valve 9.

The control portion C may be configured to specifically include, as hardware materials, although not illustrated, the acceleration sensor 20, an A/D converter for retrieving a signal output by the detecting portion 10, a memory device, e.g., a read only memory (ROM) that stores a program used for processing necessary for control of the damping force of the semiactive damper C on the basis of the acceleration a filtered by the band pass filter 41 and the signal output by the detecting portion 10, a calculation device, e.g, a central processing unit (CPU) for executing processing based on the program, and a memory device, e.g, a random access memory (RAM), for providing a memory region to the CPU. The portions of the control processing portion 42 of the control portion C are achieved by execution of the program of the CPU. In addition, the band pass filter 41 may be achieved by execution of the program of the CPU.

As described above, the semiactive damper C includes the cylinder 1, the rod 2 movably inserted into the cylinder 1, the piston 3 slidably inserted into the cylinder 1 and comparting the interior of the cylinder 1 into the rod-side chamber 4 and the piston-side chamber 5, the tank 6, the suction passage 7, the damping passage 8, the variable damping valve 9, and the detecting portion 10. The semiactive damper D configured in the above manner can determine whether it is currently in the expansion. operation or contraction operation and adjust the damping force. Thus, under the situation that the damping force in a direction. in which the vibration of the vehicle body B, which. is a vibration control subject, can be suppressed can be exhibited, the semiactive damper D exhibits the damping force. Under the situation that the vehicle body B is vibrated when the damping force is exhibited, the damping force can be reduced. Therefore, the semiactive damper D of the present invention does not require the first opening/closing valve or the second opening/closing valve of the conventionally semiactive damper, and can function as a skyhook damper. From the above, with the semiactive damper D of the present invention, it is not necessary to include the first opening/closing valve or the second opening/closing valve so that. the entire apparatus can be reduced in size and the manufacturing cost can be inexpensive. In addition, with the semiactive damper D of the present invention, it is not necessary to include the first opening/closing valve or the second. opening/closing valve that generates a response delay in opening and closing. Therefore, even when vibrations at a high frequency occur in the vehicle body B and the trolley T under the situation that a large damping force is exhibited, the vehicle body B and the trolley T are not vibrated, and chatter vibration does not occur. Thus, with the semiactive damper D of the present invention, not only the size and the cost can be reduced, but also the vehicle ride quality can be increased.

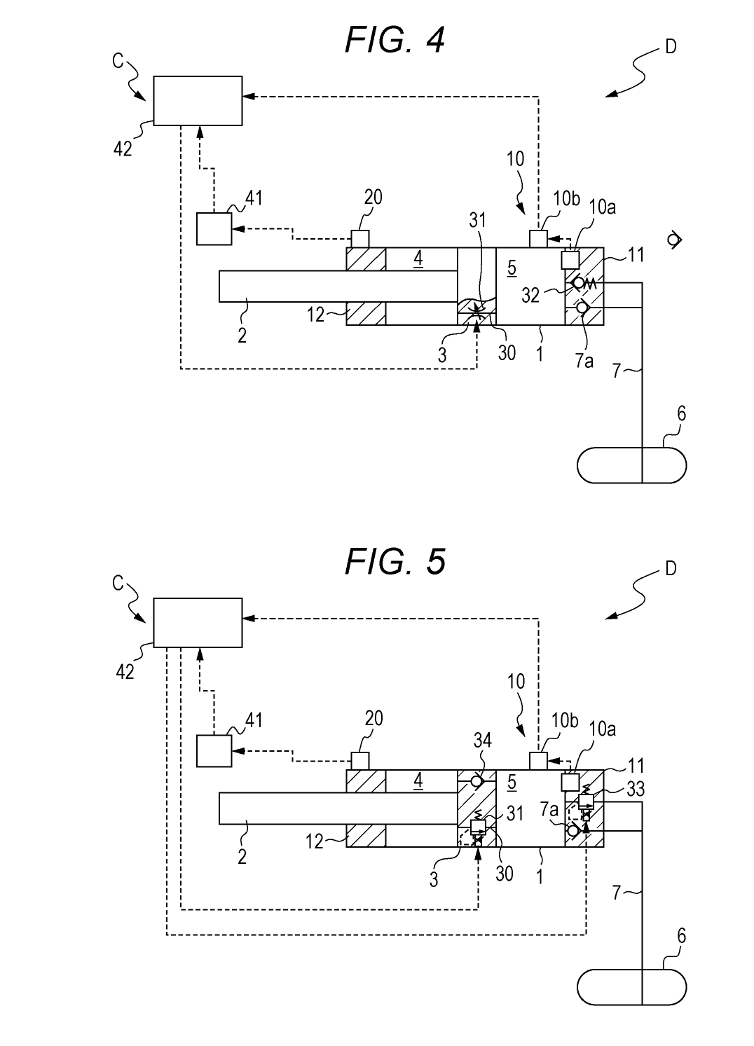

In addition, the semiactive damper D of the present example includes the flow straightening passage 13 that permits only the flow of the hydraulic oil from the piston-side chamber 5 to the rod-side chamber 4, and the damping passage 8 communicates the rod-side chamber 4 with the tank 6. The semiactive damper D configured in the above manner is set to a uniflow type in which the hydraulic oil is circulated in one way in the order of the piston-side chamber 5, the rod-side chamber 4, and the tank 6. In the case of the expansion and contraction operation, the hydraulic oil invariably passes the variable damping valve 9 from the cylinder 1 and is discharged from the tank 6. Thus, in the case of the semiactive damper D configured in the above manner, the damping force can be varied with the single variable damping valve 9 alone, and the apparatus can be reduced in size and cost more effectively. When the semiactive damper D is set to a biflow type, as illustrated in FIG. 4, the flow straightening passage 13 is eliminated from the structure of FIG. 1, a damping passage 30 communicating the piston-side chamber 5 with the rod-side chamber 4, a variable damping valve 31 that is provided on the damping passage 30 and permits a bidirectional flow, and a base valve 32 that applies resistance to the flow of the hydraulic oil from the piston-side chamber 5 to the tank 6 may be provided. In addition, when the semiactive damper D is set to a biflow type, as illustrated in FIG. 5, a variable damping valve 33 may be provided instead of the base valve 32 of the structure of FIG. 4, and a check valve 34 that permits only the flow of the hydraulic oil from the piston-side chamber 5 to the rod-side chamber 4 may be provided. In. this case, it is preferable that a one-way damping valve be employed as the variable damping valves 31, 33.

In addition, the semiactive damper D of the present example includes the acceleration sensor 20 attached to the cylinder 1. The cylinder 1 is coupled to the vehicle body B, which is a vibration control subject. The semiactive damper D configured in the above manner can detect an acceleration almost equal to the acceleration of the vehicle body B, and the necessity of a wiring operation with an external acceleration sensor, control device or the like is removed. Vibration control based on the Karnopp control law can be achieved. by merely setting the semiactive damper D on a rail vehicle. When not only the acceleration. sensor 20, but also the control portion C is integrated with the cylinder 1, a wiring operation can be completed merely by connection of a power source to the control portion C. Therefore, the operation of mounting on a rail vehicle can be easier.

Furthermore, when the damping force cannot be exhibited from the expansion and contraction direction detected by the detecting portion 10 in a direction in which the vibration of the vehicle body B, which is a vibration control subject, is suppressed, the semiactive damper D of the present example minimizes the damping force. Therefore, the semiactive damper D can function as a skyhook damper on the basis of Karnopp control law, and a large vibration control effect can be obtained.

When the damping force cannot be exhibited. from the expansion and contraction direction detected by the detecting portion 10 in a direction in which the vibration of the vehicle body B, which is a vibration control subject, is suppressed, the damping force may not be minimized, and a soft damping force larger than the minimum or a medium damping force between the minimum and the maximum may be exhibited. In this case, regarding the damping force calculation portion 421, when the reference symbol of the velocity V is positive and the signal from the detecting portion 10 indicates expansion or when the reference symbol of the velocity V is negative and the signal from the detecting portion 10 indicates contraction, it is sufficient that the damping force F is set to a soft or medium damping force. It is sufficient to set the degree of the soft and medium damping forces depending on a rail vehicle. As described above, when the damping force is set to soft or medium, the vibration of the vehicle body B becomes slightly large. However, the vibration of the trolley T can be suppressed, and the vibration situation of a rail vehicle stabilizes. Therefore, vibration of the trolley T can also be suppressed without impairment of the ride quality.

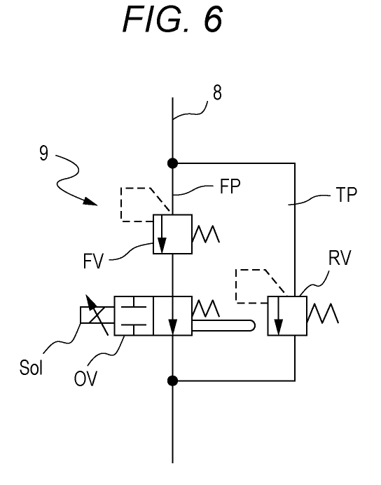

In addition, as illustrated in FIG. 6, the configuration of the variable damping valve 9 may be configured, for example, of a damping force adjustment passage IP and a fail passage FP provided in parallel on the damping passage 8, a relief valve portion RV, an opening/closing valve portion OV, and a solenoid Sol.

The relief valve portion RV is provided on the damping force adjustment passage 18, and the opening/closing valve portion OV is provided on the fail passage FP. The opening/closing valve portion OV is an electromagnetic opening/closing valve that is biased by a spring to open and is closed by being subject. to the thrust force from the solenoid Sol. In addition, the opening/closing valve portion. OV is a normally open opening/closing valve that is biased by a spring when the solenoid Sol is not energized and communicates the fail passage FP, and disconnects the fail passage FP when a predetermined amount of current is supplied to the solenoid Sol.

The relief valve portion RV is adapted to be driven by the thrust force from the solenoid Sol via the opening/closing valve portion OV and is adapted to maximize the valve opening pressure by being biased by a spring when the solenoid Sol is not energized. In addition, when the opening/closing valve portion OV is brought into a disconnection position by energization of the solenoid Sol, the thrust force of the solenoid Sol is adapted to act on the relief valve portion RV as a force against the spring via the opening/closing valve portion OV. Therefore, when the solenoid Sol is energized, the valve opening pressure of the relief valve portion RV can be adjusted depending on the amount of applied current. When the amount of applied current becomes large, the valve opening pressure of the relief valve portion RV becomes small. In contrast, in a state where the solenoid Sol is not energized, the valve opening pressure of the relief valve portion RV becomes maximum. As described above, with the variable damping valve 9 of the present example, the adjustment of the valve opening pressure of the relief valve portion RV and the opening and closing of the opening/closing valve portion OV can be made with the single solenoid Sol.

In addition, in the present example, the fail passage FP is provided with the fail valve portion FV. This fail valve portion FV is adapted to open when the pressure on the upstream side becomes a predetermined. pressure in a state where the fail passage FP is communicated by the opening/closing valve portion OV. The valve opening pressure is set to a value smaller than the maximum valve opening pressure of the relief valve portion RV.

Thus, this variable damping valve 9 disconnects the opening/closing valve portion OV and can adjust. the valve opening pressure of the relief valve portion RV to control the damping force of the semiactive damper D when the solenoid Sol is energized in a normal time in which the variable damping valve 9 can function normally.

In addition, in the case of fail (abnormal time) in which the solenoid Sol cannot be energized, the opening/closing valve portion OV is opened and communicates the fail passage FP. The fail valve portion FV is determined to be effective, and the fail valve portion FV exhibits the damping force at the time of the expansion and contraction of the semiactive damper D. Thus, in the case of fail, the semiactive damper D functions as a passive damper.

A preferable embodiment of the present invention has been described in detail. However, a reconstruction, a variation. and a modification. may be made without departing from the scope of the claims.

The present application claims priority based on JP Application No. 2016-167521 filed with the Japan Patent Office on Aug. 30, 2016, which is incorporated herein by reference in its entirety.

1. A semiactive damper comprising:
a cylinder;
a rod configured to be movably inserted into the cylinder;
a piston configured to be slidably inserted into the cylinder and compart an interior of the cylinder into a rod-side chamber and a piston-side chamber;
a tank;
a suction passage configured to permit only flow of a hydraulic fluid from the tank to the piston-side chamber;
a damping passage configured to communicate the rod-side chamber with the tank or the rod-side chamber with the piston-side chamber;
a variable damping valve provided on the damping passage; and
a detecting portion configured to detect an expansion and contraction direction according to pressure in the piston-side chamber,
wherein the semiactive damper suppresses vibrations of a vibration control subject.

2. The semiactive damper according to claim 1, comprising
a flow straightening passage configured to permit only flow of a hydraulic fluid from the piston-side chamber to the rod-side chamber,
wherein the damping passage communicates the rod-side chamber with the tank.

3. The semiactive damper according to claim 1, comprisng
an acceleration sensor attached to the cylinder,
wherein the cylinder is coupled to the vibration control subject.

4. The semiactive damper according to claim 1,
wherein a damping force is minimized when a damping force cannot be exhibited from an expansion and contraction direction detected by the detecting portion to a direction in which vibrations of the vibration control subject are suppressed.

5. The semiactive damper according to claim 1,
wherein a damping force is set to soft larger than minimum or to medium between minimum and maximum when a damping force cannot be exhibited from an expansion and contraction direction detected by the detecting portion to a direction in which vibrations of the vibration control subject are suppressed.
